(19) United States
(12) Patent Application Publication
(10) Pub. No.: US 2006/0103941 A1
(43) Pub. Date: May 18, 2006

(54) Microlens manufacturing method and solid-state image pickup device manufacturing method

(75) Inventors: Keiichi Yamaguchi, Anpachi-gun (JP); Seiji Kai, Anpachi-gun (JP)

Correspondence Address: OLIFF & BERRIDGE, PLC, P.O. BOX 19928, ALEXANDRIA, VA, 22320, US

(73) Assignee: SANYO ELECTRIC CO., LTD., Moriguchi-shi (JP)

(21) Appl. No.: 11/272,694

(22) Filed: Nov. 15, 2005

(30) Foreign Application Priority Data
Nov. 16, 2004 (JP) 2004-332209

(51) Int. Cl. G02B 27/10

(52) U.S. Cl. 359/619

(57) ABSTRACT

In order to efficiently form microlenses wide in light receiving surfaces, microlenses are manufactured according to the following process. A first light transmitting film on which columnar projections are formed with a predetermined interval is formed on a semiconductor substrate. A second light transmitting film made of a material same as that of the first light transmitting film is laminated on a surface of the first light transmitting film, and a planar shape of the projection is enlarged to make a separation between the projections narrower. Argon ions are irradiated onto the second light transmitting film to round off a corner of the second light transmitting film, and thereby a lens is formed.

### BACKGROUND OF THE INVENTION

1. Field of the Invention

The invention relates to a method for manufacturing a microlens and a method for manufacturing a solid-state image pickup device equipped with microlenses.

2. Description of the Related Art

Recently, demand for higher pixel density is high in CCD image pickup devices and CMOS image pickup devices. A simple increase in the number of pixels results in an increase in a size of the image pickup device. However, in a small-size image pickup device that is incorporated in a mobile device such as a portable telephone, an increase in the size of the image pickup device cannot be permitted. Accordingly, in a small-size image pickup device, the higher pixel density is realized by making the area of each light receiving pixel smaller.

When an area of each of light receiving pixels is made smaller, since an area receiving light corresponding to a subject becomes smaller, the sensitivity of the image pickup device deteriorates. As a countermeasure to this, a configuration where a microlens is formed for each light receiving pixel of the image pickup device is known. Since the microlens can condense light from an area larger than an area of the light receiving pixel on the corresponding light receiving pixel to generate information electric charges corresponding to an amount of condensed light, the sensitivity of the image pickup device can be improved.

In an image pickup device provided with the microlenses, in order to improve the sensitivity, it is necessary to form microlenses having wide light receiving areas to efficiently make use of light incident on the image pickup device. However, it has been difficult to efficiently form microlenses with wide light receiving surfaces on a substrate on which light receiving pixels are formed.

### SUMMARY OF THE INVENTION

In this regard, the invention provides a method for manufacturing a microlens having a wide light receiving surface and a method for manufacturing an image pickup device provided with microlenses having wide light receiving surfaces.

The manufacturing method according to the invention includes; forming a first light transmitting film with projections formed at a predetermined separation on a substrate; forming a second light transmitting film on the first light transmitting film; and irradiating gas ions toward the second light transmitting film.

### BRIEF DESCRIPTION OF THE DRAWINGS

FIG. 1A is a sectional view showing a state where a first light transmitting film is formed in the forming microlenses in a first embodiment.

FIG. 1B is a sectional view showing a state where a mask is formed with a photoresist in the forming microlenses in the first embodiment.

FIG. 1C is a sectional view showing a state where the first light transmitting film is etched in the forming microlenses in the first embodiment.

FIG. 2A is a sectional view showing a state after the photoresist is removed in the forming microlenses in the first embodiment.

FIG. 2B is a sectional view showing a state where a second light transmitting film is formed in the forming microlenses in the first embodiment.

FIG. 2C is a sectional view showing a lens shape obtained by irradiating gas ions in the forming microlenses in the first embodiment.

FIG. 3A is a plan view in a state where projections of the first light transmitting film are formed in the forming microlenses in the first embodiment.

FIG. 3B is a plan view showing a state where a second light transmitting film is formed in the forming microlenses in the first embodiment.

FIG. 3C is a plan view showing a state after the gas ions are irradiated in the forming microlenses in the first embodiment.

FIG. 4A is a sectional view showing a state where the photoresist is removed in the forming microlenses in a second embodiment.

FIG. 4B is a sectional view showing a state where a second light transmitting film is formed in the forming microlenses in the second embodiment.

FIG. 4C is a sectional view showing a lens shape obtained by irradiating gas ions in the forming microlenses in the second embodiment.

### DESCRIPTION OF THE PREFERRED EMBODIMENTS

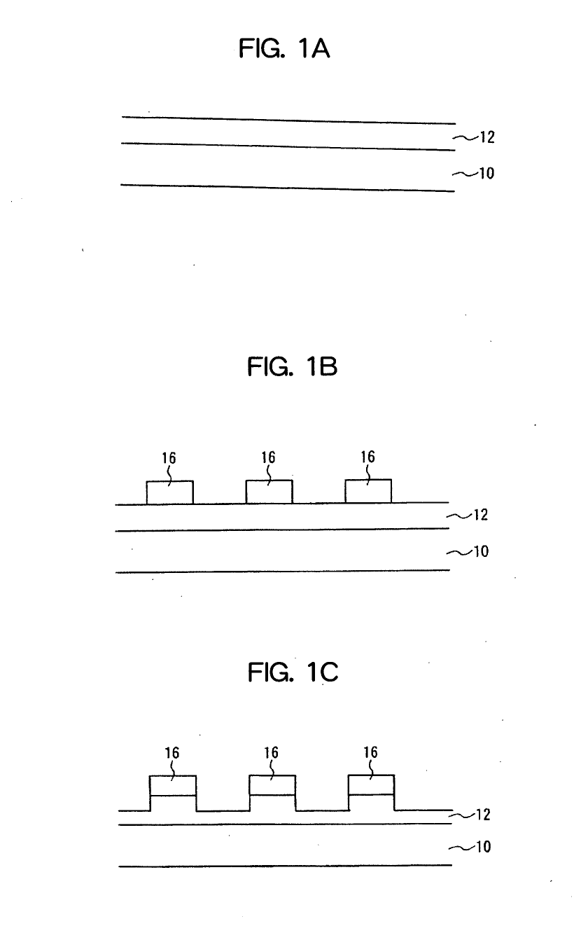

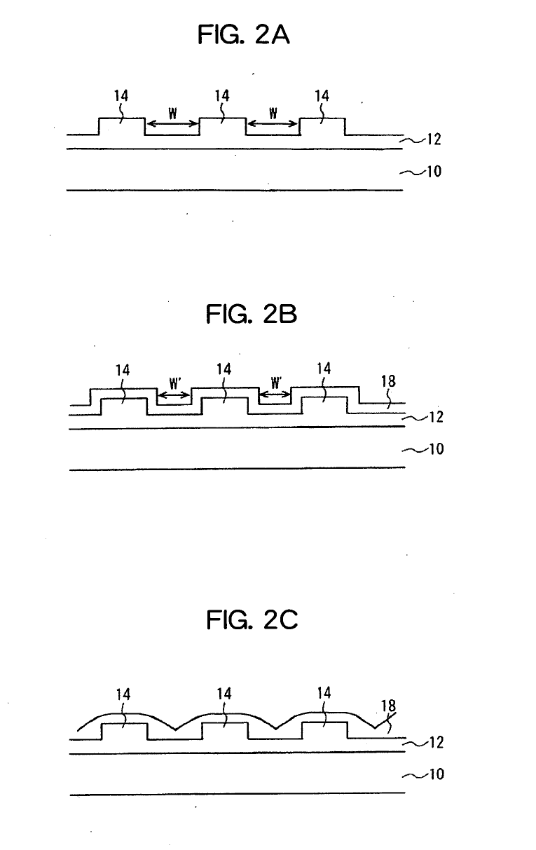

FIGS. 1A, 1B, 1C, 2A, 2B and 2C are diagrams for explaining steps in the forming an image pickup device provided with microlenses in a first embodiment according to the invention. Firstly, as shown in FIG. 1A, a first light transmitting film 12 is formed on a surface of a semiconductor substrate 10. Here, a plurality of light receiving pixels is formed on a surface of the semiconductor substrate 10. The light receiving pixels can be formed according to a well-known manufacturing method. The first light transmitting film 12 is made of a light transmitting material; for instance, a silicon nitride film or a silicon oxide film can be used. The first light transmitting film 12 can be formed by use of various kinds of deposition technologies such as a CVD (Chemical Vapor Deposition) method, a PVD (Physical Vapor Deposition) method and so on.

In the next place, as shown in FIG. 1B, at a position where a lens is being formed on a surface of the first light transmitting film 12, a photoresist film 16 that becomes a mask to the etching mentioned below is formed. When a plurality of light receiving pixels is formed on the semiconductor substrate 10 as in the configuration described here, a photoresist film 16 is formed on a top of each of positions where the plurality of light receiving pixels is formed. After a photoresist is coated on the first light transmitting film, the photoresist is patterned with an exposing device to form photoresist films 16 at positions corresponding to the lenses.

Then, as shown in FIG. 1C, the first light transmitting film 12 on which the photoresist films 16 are formed is etched. The etching process may be any of a dry process and a wet process. An amount of etching can be determined in accordance with a necessary height of a lens. In a first embodiment, with the dry etching process, etching is preferably applied only in a direction vertical to a surface of the semiconductor substrate 10.

Subsequently, as shown in FIG. 2A, the photoresist films 16 are removed. Thus, in the first light transmitting film 12, pillar projections 14 are formed. A shape of the projection 14 can be determined in conformity with a shape of a plurality of light receiving pixels formed on the semiconductor substrate 10. For instance, when the light receiving pixel is formed in a rectangular shape, the projection 14 is preferably formed into a rectangular parallelepiped.

In the next place, as shown in FIG. 2B, a second light transmitting film 18 is formed on the first light transmitting film 12 provided with the projection 14. The second light transmitting film 18 is formed, by use of a CVD method, with a substantially uniform thickness, on an exposed surface of the first light transmitting film 12 provided with the projections 14. In the formation of the second light transmitting film 18, other than the CVD method, any deposition method that can form a film with a substantially uniform thickness on an exposed surface can be used. The second light transmitting film 18 is preferably formed of a light transmitting material same as that of the first light transmitting film 12. When the first light transmitting film 12 is formed of a silicon nitride film, the second light transmitting film 18 is also formed of a silicon nitride film.

Thereafter, gas ions are irradiated onto the second light transmitting film 18 having projections corresponding to the projections 14 formed on the semiconductor substrate 10. The gas ions are irradiated with an intention of rasping off corners of the projections. Here, the gas ions are preferably ions of an inert gas. As the inert gas ions, argon ions can be used; however, other inert gas ions may be used. When argon ions are irradiated on the first and second light transmitting films 12 and 18, an argon ion plasma is generated, and an electric field is applied to the generated plasma to allow the argon ions to irradiate (bombard) the second light transmitting film 18. At this time, the kinetic energy of the argon ions is controlled in its magnitude so that bonds of surface atoms or molecules of the second light transmitting film 18 may be broken to allow recombining with other atoms or molecules in an irradiation direction (so that the surface atoms or molecules may move only toward the proximity of the projection 14).

In the argon ion-irradiated first and second light transmitting films, as shown in FIG. 2C, the corners of the second light transmitting film 18 formed on the projection 14 are rasped off and the rasped portion is displaced in the proximity of the projection. Thus, a curved portion is formed on the second light transmitting film 18 on the projection 14, and thereby the first and second light transmitting films combine to form a lens.

By undergoing a step of irradiating gas ions, in a portion of the second light transmitting film 18 where the projection 14 is not located as well, a curved portion is extended, and thereby a lens with a wide light receiving surface can be efficiently formed.

After the projections 14 are formed on the first light transmitting film, the argon ions are irradiated to rasp off corners of the projections 14, whereby microlenses can be formed as well. In this case, in order to form a lens with a wide light receiving surface, a distance W between the projections 14 is necessary to be designed optimally so as to bring adjacent lenses into contact with each other. However, the distance W between the projections 14 is restricted by exposure technology.

On the other hand, in the first embodiment, the second light transmitting film is formed on the first light transmitting film 12 provided with the projections 14. Accordingly, a distance W′ between adjacent projections can be made smaller than a distance W between the projections 14. At this time, by controlling a film thickness of the second light transmitting film, the distance W′ between adjacent projections can be controlled. Accordingly, in a lens formed by combining the first and second light transmitting films, a light receiving surface can be made larger by irradiating the argon plasma, resulting in improving the sensitivity of an image pickup device.

In the first embodiment, a rectangular parallelepiped projection 14 is formed on a rectangular light receiving pixel. However, the method is not restricted thereto. For instance, in the case of the light receiving pixel having a hexagonal shape, when a projection 14 having a hexagonal columnar shape is formed, a lens with a wide light receiving surface in accordance with a shape of the light receiving pixel can be efficiently formed.

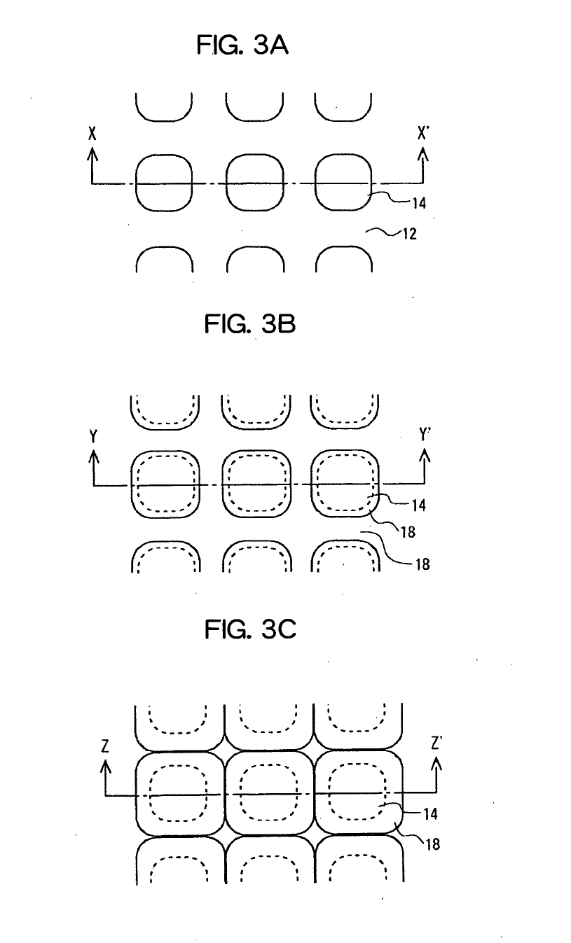

FIGS. 3A, 3B and 3C, respectively, are plan views showing a manufacturing step of microlenses according to the first embodiment. In FIG. 3A, projections 14 formed on a first light transmitting film are shown. The projections 14 are formed on tops of a plurality of light receiving pixels formed on a surface of a semiconductor substrate 10. A sectional diagram along a line X-X′ in the drawing corresponds to FIG. 2A. FIG. 3B shows a state where a second light transmitting film 18 is formed on the first light transmitting film 12 on which the projections 14 are formed. The second light transmitting film 18 is formed with a substantially uniform film thickness on an exposed surface of the first light transmitting film 12 on which the projections 14 are formed. A sectional diagram along a Y-Y′ line in the drawing corresponds to FIG. 2B. FIG. 3C shows a state after the gas ions are irradiated onto the second light transmitting film 18. Thus, a curved portion is formed in the second light transmitting film 18 on the projection 14, and thereby the first and second light transmitting films 12 and 18 formed in a lens shape can be obtained. A sectional diagram along a Z-Z′ line in the drawing corresponds to FIG. 2C.

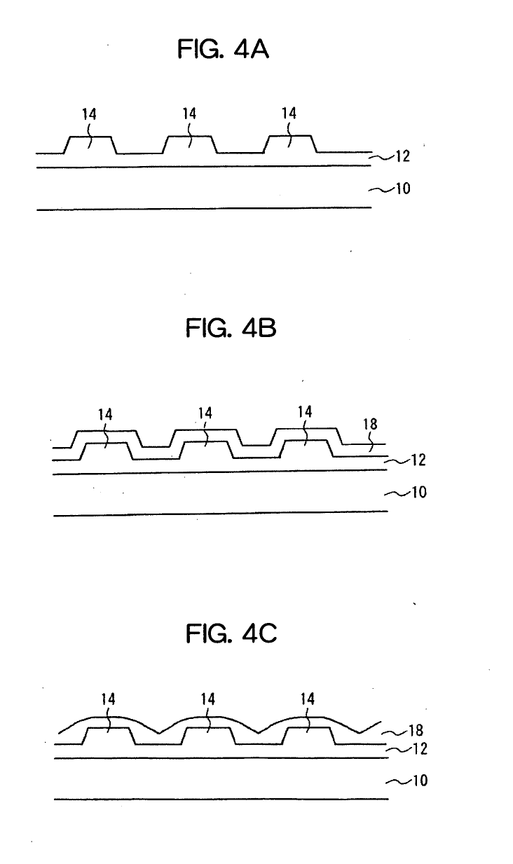

FIGS. 4A, 4B and 4C, respectively, are diagrams for explaining steps for forming an image pickup device provided with microlenses in a second embodiment according to the invention. As shown in FIG. 4A, a first light transmitting film 12 on which projections 14 are formed is formed on a semiconductor substrate 10. A second embodiment is different from the first embodiment in a point in that projections 14 are formed in taper. A taper-like projection 14 in the second embodiment can be formed by applying the wet etching or the dry etching to the first light transmitting film on which a photoresist film shown in FIG. 1B is formed.

Later steps are similar to that of the first embodiment. As shown in FIG. 4B, a second light transmitting film 18 is formed on the first light transmitting film 12 on which the taper-like projections 14 are formed. The second light transmitting film 18 is formed with a substantially uniform film thickness on an exposed surface of the first light transmitting film 12 on which the taper-like projections 14 are formed. In the next place, the gas ions are irradiated to the second light transmitting film 18. Thus, as shown in FIG. 4C, a curved portion is formed on the second light transmitting film 18 on the taper-like projection 14, and thereby the first and second light transmitting films are formed into a lens shape.

In the second embodiment, when the projection 14 is formed to be taper-like, a curvature of the curved portion of the first and second light transmitting films 12 and 18 that are formed in a lens shape can be controlled. Accordingly, a lens having a desired curvature can be efficiently formed.

As described above according to the embodiments, according to the invention, a microlens having a wide light receiving surface can be efficiently formed and thereby light incident on a image pickup device can be efficiently utilized; accordingly, the sensitivity of the image pickup device can be improved.

What is claimed is:

1. A manufacturing method of at least one microlens comprising:
forming, on a substrate, a first light transmitting film on a top surface where a plurality of projections is formed with a predetermined separation from each other;
laminating a second light transmitting film on a surface of the first light transmitting film; and
irradiating gas ions onto the second light transmitting film.

2. The manufacturing method of at least one microlens according to claim 1, wherein the projection is columnar.

3. The manufacturing method of at least one microlens according to claim 1, wherein the projection is formed taper-like.

4. The manufacturing method of at least one microlens according to claim 1, wherein the first and second light transmitting films are made of a same light transmitting material.

5. The manufacturing method of at least one microlens according to claim 1, wherein the second light transmitting film is laminated with a substantially uniform film thickness on a planar portion of the first light transmitting film and a side surface of the projection.

6. The manufacturing method of at least one microlens according to claim 1, wherein the irradiating gas ions onto the second light transmitting film rasps off a corner of a projection of the second light transmitting film formed corresponding to the projection of the first light transmitting film and moves a material constituting the corner to a surface of the second light transmitting film in the proximity of the corner.

7. A manufacturing method of an image pickup device comprising:
forming a plurality of light receiving pixels on a semiconductor substrate;
forming, on the semiconductor substrate, a first light transmitting film in which projections are formed corresponding to positions where the plurality of light receiving pixels are formed;
laminating a second light transmitting film on a surface of the first light transmitting film; and
irradiating gas ions toward the second light transmitting film.

8. The manufacturing method of an image pickup device according to claim 7, wherein the projection is columnar.

9. The manufacturing method of an image pickup device according to claim 7, wherein the projection is formed taper-like.

10. The manufacturing method of an image pickup device according to claim 7, wherein the first and second light transmitting films are made of a same light transmitting material.

11. The manufacturing method of an image pickup device according to claim 7, wherein the projection has a planar shape in accordance with a shape of the light receiving pixel.

12. The manufacturing method of an image pickup device according to claim 7, wherein the second light transmitting film is laminated with a substantially uniform film thickness on a planar portion of the first light transmitting film and a side surface of the projection.

13. The manufacturing method of an image pickup device according to claim 7, wherein the irradiating gas ions onto the second light transmitting film rasp off a corner of a projection of the second light transmitting film formed corresponding to the projection of the first light transmitting film and moves a material constituting the corner onto a surface of the second light transmitting film in the proximity of the corner.
